(19) United States
(12) Patent Application Publication
(10) Pub. No.: US 2020/0117033 A1
(43) Pub. Date: Apr. 16, 2020

(54) LIQUID CRYSTAL DISPLAY AND MANUFACTURING METHOD THEREOF

(71) Applicant: Samsung Display Co., Ltd., Yongin-Si (KR)

(72) Inventors: Hyun Wook LEE, Asan-si (KR); Jae Ho CHOI, Asan-si (KR); Chan Young LIM, Cheonan-si (KR); Sol Ip JEONG, Namyangju-si (KR)

(21) Appl. No.: 16/654,079

(22) Filed: Oct. 16, 2019

(30) Foreign Application Priority Data
Oct. 16, 2018 (KR) 10-2018-0123353

(51) Int. Cl. G02F 1/1362; G02F 1/1345; G02F 1/1337

(52) U.S. Cl. CPC G02F 1/1362; G02F 1/1368; G02F 1/133711; G02F 1/13458

(57) ABSTRACT

An exemplary embodiment of the present inventive concept provides a liquid crystal display including: a first substrate including a display area and a non-display area; a second substrate overlapping the first substrate; a liquid crystal layer disposed between the first substrate and the second substrate; and a testing pad disposed adjacent to the display area of the first substrate and connected to the display area, wherein a first voltage applying pad and a second voltage applying pad disposed in a region of the first substrate that does not overlap with the second substrate, and each of the first voltage applying pad and the second voltage applying pad may be connected to the testing pad.

### CROSS-REFERENCE TO RELATED APPLICATION

This application claims priority to and the benefit of Korean Patent Application No. 10-2018-0123353 filed in the Korean Intellectual Property Office on Oct. 16, 2018, the entire contents of which are incorporated herein by reference.

### BACKGROUND

### (a) Technical Field

The present disclosure relates to a liquid crystal display and a manufacturing method thereof, and more particularly, to a manufacturing method of applying a voltage through a lower substrate in a UV irradiation process for forming a pretilt of liquid crystal molecules, and a liquid crystal display manufactured by the manufacturing method.

### (b) Description of the Related Art

As one of the most widely used types of flat panel displays at present, a liquid crystal display includes two display panels formed with electric field generating electrodes, and a liquid crystal layer interposed between the two display panels. The LCD is realized by applying a voltage to the electrodes and realigning liquid crystal molecules of a liquid crystal layer so as to adjust an amount of transmitted light.

In order to obtain a quick response speed of the LCD, various initial alignment methods for pretilting liquid crystal molecules have been proposed. Among the various initial alignment methods, in an alignment method in which prepolymers polymerized by light such as ultraviolet rays are used to pretilt the liquid crystal molecules, the field generating electrodes are respectively applied with desired voltages and are then exposed to the light.

The above information disclosed in this Background section is only for enhancement of understanding of the background of the inventive concept, and therefore it may contain information that does not form the prior art that is already known in this country to a person of ordinary skill in the art.

### SUMMARY

The present inventive concept has been made in an effort to provide a liquid crystal display and a manufacturing method thereof that may omit a process of cutting an upper substrate when applying an alignment voltage for forming a pretilt.

An exemplary embodiment of the present inventive concept provides a liquid crystal display including: a first substrate including a display area and a non-display area; a second substrate overlapping the first substrate; a liquid crystal layer disposed between the first substrate and the second substrate; and a testing pad disposed adjacent to the display area of the first substrate and connected to the display area, wherein a first voltage applying pad and a second voltage applying pad disposed in a region of the first substrate that does not overlap with the second substrate, and each of the first voltage applying pad and the second voltage applying pad is connected to the testing pad.

A first diode may be disposed between the testing pad and the first voltage applying pad, and a second diode may be disposed between the testing pad and the second voltage applying pad.

Each of the first diode and the second diode may be connected to a transistor.

The testing pad may include a plurality of pads, some of the plurality of pads may be connected to the first voltage applying pad, and some of the plurality of pad portions may be connected to the second voltage applying pad.

A plurality of pad connecting portions may be disposed between the first voltage applying pad and the testing pad, and a pad connecting portion may be disposed between the second voltage applying pad and the testing pad.

The testing pad may be connected to a data line and a gate line of the display area.

A first electrode may be disposed on the first substrate, and a second electrode may be disposed on the second substrate.

The testing pad may be connected to a short spacer disposed in the display area, and the short spacer may be connected to the second electrode.

The first substrate may be formed as a whole body.

Another exemplary embodiment of the present inventive concept a manufacturing method of a liquid crystal display, including: preparing a mother substrate that includes a first substrate including a display area and a non-display area, a second substrate overlapping the first substrate, and a liquid crystal layer disposed between the first substrate and the second substrate; applying a voltage to the mother substrate; and forming a pretilt in the liquid crystal layer by irradiating UV on the mother substrate to which the voltage is applied, wherein the first substrate includes a testing pad disposed adjacent to the display area of the first substrate and connected to the display area, a first voltage applying pad and a second voltage applying pad are disposed in a region of the first substrate that does not overlap with the second substrate, and each of the first voltage applying pad and the second voltage applying pad is connected to the testing pad.

In the applying of the voltage to the mother substrate, a voltage applying probe may contact each of the first voltage applying pad and the second voltage applying pad to apply the voltage.

The liquid crystal layer may include a liquid crystal molecule and a reactive mesogen.

The reactive mesogen may include a photoreactor.

A first diode may be disposed between the testing pad and the first voltage applying pad, and a second diode may be disposed between the testing pad and the second voltage applying pad.

Each of the first diode and the second diode may be connected to a transistor.

The testing pad may include to a plurality of pads, some of the plurality of pads may be connected to the first voltage applying pad, and some of the plurality of pads may be connected to the second voltage applying pad.

A plurality of pad connecting portions may be disposed between the first voltage applying pad and the testing pad, and a pad connecting portion may be disposed between the second voltage applying pad and the testing pad.

The manufacturing method of the liquid crystal display may further include cutting and removing a non-display area in which the first voltage applying pad, the second voltage applying pad, the first diode, the second diode, and the plurality of pads are disposed from the mother substrate.

A first voltage may be supplied to a first electrode of the display area via the first voltage applying pad, the plurality of pad connecting portions and the testing pad.

A second voltage may be supplied to a second electrode of the display area via the second voltage applying pad, the pad connecting portion, the testing pad and a short spacer disposed in the display area.

According to the embodiments, it is possible to omit a process of cutting an upper substrate when applying an alignment voltage for forming a pretilt.

### BRIEF DESCRIPTION OF THE DRAWINGS

FIG. 1 schematically illustrates a liquid crystal display according to an embodiment of the present inventive concept.

FIG. 2 illustrates a first substrate of a liquid crystal display according to an embodiment of the present inventive concept.

FIG. 3 illustrates a liquid crystal display according to a comparative example of the present inventive concept.

FIG. 4 illustrates a cross-sectional view taken along line IV-IV of FIG. 3.

FIG. 5A to FIG. 5D illustrate a process of forming a pretilt of a liquid crystal display according to an embodiment of the present inventive concept.

FIG. 6 illustrates a cutting line of the first substrate in a liquid crystal display according to an embodiment of the present inventive concept.

FIG. 7 illustrates a layout diagram of a liquid crystal display according to an embodiment of the present inventive concept.

FIG. 8 illustrates a cross-sectional view taken along line VIII-VIII′ of FIG. 7.

### DETAILED DESCRIPTION OF THE EMBODIMENTS

The present inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the present disclosure.

To clearly describe the present disclosure, portions which do not relate to the description are omitted, and like reference numerals designate like elements throughout the specification.

Further, in the drawings, the size and thickness of each element are arbitrarily illustrated for ease of description, and the present disclosure is not necessarily limited to those illustrated in the drawings. In the drawings, the thicknesses of layers, films, panels, regions, etc., are exaggerated for clarity. In the drawings, for ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

Hereinafter, a liquid crystal display and a manufacturing method thereof according to an embodiment of the present inventive concept will be described in detail with reference to the accompanying drawings.

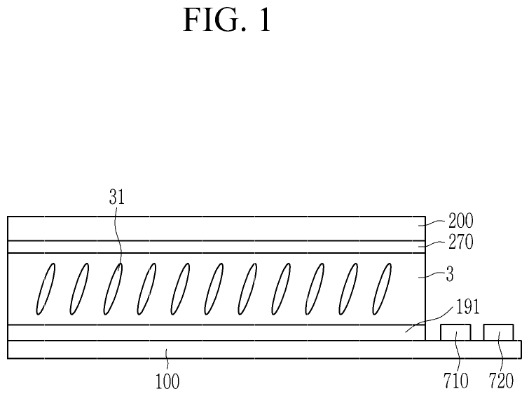

FIG. 1 schematically illustrates a liquid crystal display according to an embodiment of the present inventive concept. Referring to FIG. 1, a liquid crystal display according to an embodiment of the present inventive concept includes a first substrate 100 and a second substrate 200 facing each other, and a liquid crystal layer 3 disposed between the first substrate 100 and the second substrate 200, and a first voltage applying pad 710 and a second voltage applying pad 720 are disposed on one surface of the first substrate 100. Referring to FIG. 1, the second substrate 200 is smaller than the first substrate 100 such that a portion of the first substrate 100 does not overlap with the second substrate 200. The first voltage applying pad 710 and the second voltage applying pad 720 are disposed in a region of the first substrate 100 that does not overlap with the second substrate 200.

A voltage applying probe or the like is disposed on the first voltage applying pad 710 and the second voltage applying pad 720 to supply the first voltage and the second voltage to the liquid crystal display. That is, the first voltage applying pad 710 supplies a voltage to a first electrode 191 disposed on the first substrate 100, and the second voltage applying pad 720 supplies a voltage to a second electrode 270 disposed on the second substrate 200. The first voltage may be a pixel voltage transmitted to a pixel electrode, and the second voltage may be a common voltage transmitted to a common electrode.

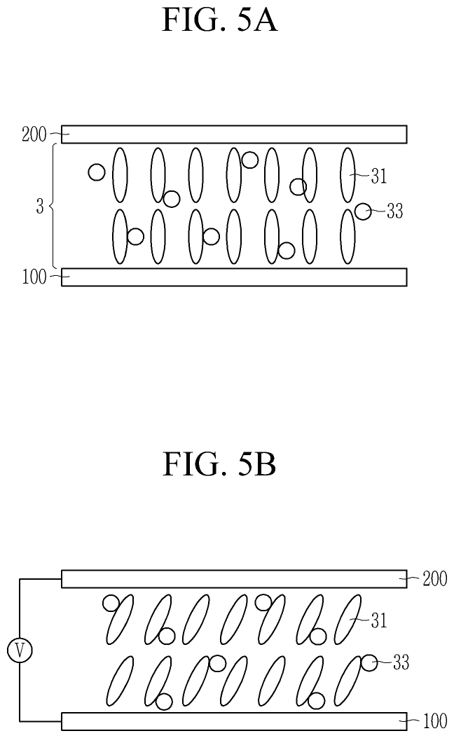

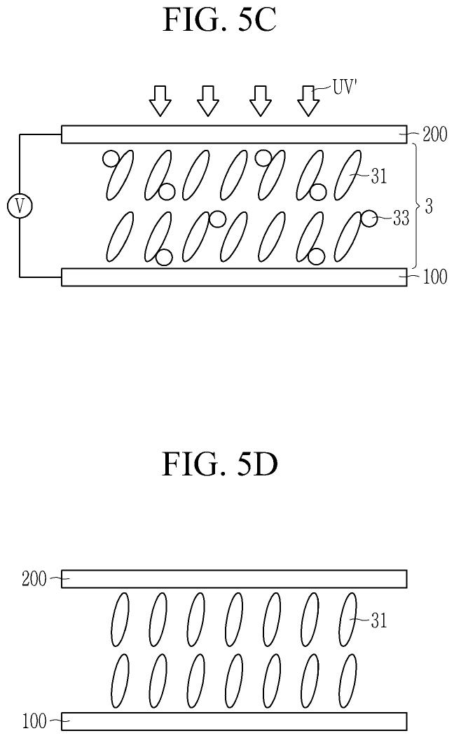

The first voltage and the second voltage alter a tilt angle of liquid crystal molecules 31 of the liquid crystal layer 3. While applying the first voltage and the second voltage, UV light is applied to the liquid crystal layer 3 including reactive mesogens to form a pretilt of the liquid crystal molecules. That is, an alignment voltage is applied using the first voltage applying pad 710 and the second voltage applying pad 720, and the pretilt may be formed in the liquid crystal layer 3. A principle of forming the pretilt will be described in detail with reference to FIG. 5.

Although not shown in FIG. 1, the first voltage applying pad 710 and the second voltage applying pad 720 are connected to a testing pad (not shown) of the liquid crystal display to supply voltages to the first electrode 191 and the second electrode 270, respectively. In this case, the first electrode 191 may be a pixel electrode, and the second electrode 270 may be a common electrode. Both the first voltage and the second voltage are supplied through the first substrate 100. Although the first voltage is directly transmitted to the first electrode 191 of the first substrate 100, the second voltage is transmitted to the second electrode 270 disposed on the second substrate 200 through a short spacer (not shown) existing in the liquid crystal display.

That is, the liquid crystal display according to the embodiment of the present inventive concept supplies the first voltage and the second voltage through the first substrate 100. The first substrate 100 may be a lower substrate and the second substrate 200 may be an upper substrate. In this case, since the first voltage and the second voltage are supplied using the testing pad (not shown) from the first substrate 100 as the lower substrate, it is possible to omit a process of cutting the second substrate 200, which is required when the voltage is supplied from the second substrate 200 as the upper substrate, and it is possible to solve a problem caused by a defective short seal.

Hereinafter, a structure of the liquid crystal display according to the embodiment of the present inventive concept will be described in detail with reference to the accompanying drawings.

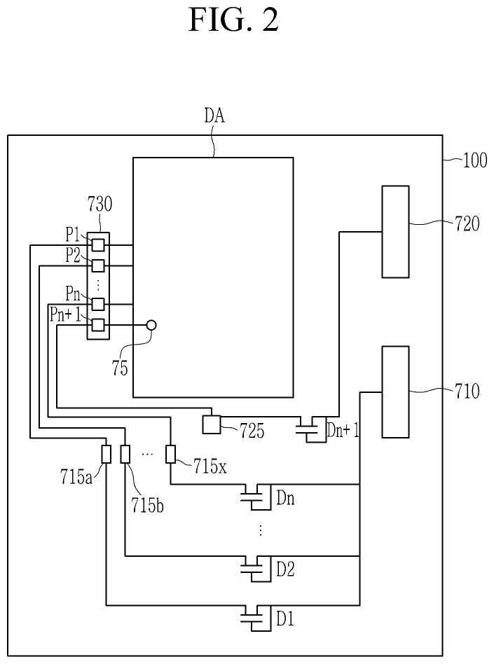

FIG. 2 illustrates a first substrate of a liquid crystal display according to an embodiment of the present inventive concept. The first substrate 100 may be a lower substrate.

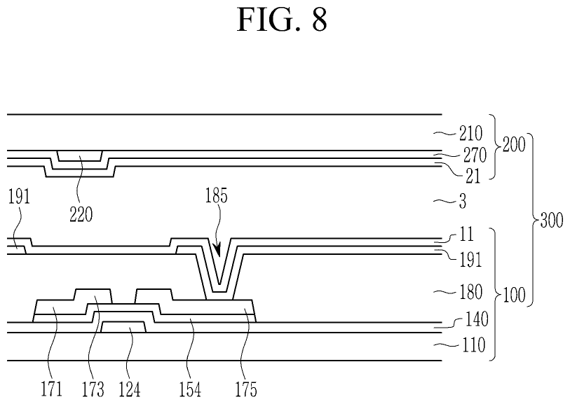

Referring to FIG. 2, the liquid crystal display according to the embodiment of the present inventive concept includes a display area DA formed on the first substrate 100. A plurality of pixels including a gate line, a data line, a semiconductor layer, and the first electrode may be disposed in the display area DA, which will be described in detail in FIG. 7 and FIG. 8.

Referring to FIG. 2, a testing pad 730 is disposed to be adjacent to the display area DA. The testing pad 730 may include a plurality of pads. Each of the plurality of pads in the testing pad 730 is connected to signal lines such as a gate line or a data line disposed in the display area DA, respectively.

Signals such as an STV signal, a VSS signal, a data signal, and a CLK signal are supplied to the display area DA through the testing pad 730. A common voltage Vcom applied to the common electrode of the display area DA is also supplied through the testing pad 730. After the liquid crystal display is completely manufactured, it is confirmed whether the liquid crystal display normally operates through the testing pad 730.

The testing pad 730 may include a plurality of pads P1, P2, . . . , Pn, and Pn+1 for supplying signals. The plurality of pads P1, P2, . . . , Pn, and Pn+1 may include a first pad P1, a second pad P2, . . . , an n-th pad Pn, and an (n+1)-th pad Pn+1. However, the number of such pads is only an example, and the liquid crystal display according to the embodiment of the present inventive concept may include various numbers of pads. “n” may vary depending on embodiments, and for example, “n” may be 30 or less.

The first pad P1, the second pad P2, . . . the n-th pad Pn may be connected to a wire disposed on a lower substrate of the display area DA. That is, the first pad P1, the second pad P2, and the n-th pad Pn are connected to the signal lines such as the gate line and the data line of the display area DA to supply the signals such as the STV signal, the VSS signal, the data signal, and the CLK signal. The (n+1)-th pad Pn+1 may be connected to the common electrode disposed on the upper substrate through the short spacer 75 disposed in the display area DA. Although the short spacer 75 is simply shown in FIG. 2 for understanding of the present inventive concept, the short spacer 75 is not limited to the position or the number shown in FIG. 2. The common voltage Vcom may be transmitted to the common electrode through the (n+1)-th pad Pn+1 and the short spacer 75. In FIG. 2, only the (n+1)-th pad is shown as a pad connected to the short spacer 75, but the present inventive concept is not limited thereto. That is, a plurality of pads may be disposed. In the liquid crystal display according to the embodiment of the present inventive concept, the voltage applying probe contacts the plurality of pads P1, P2, . . . , Pn, and Pn+1 in the testing pad 730 to supply a voltage to the display area DA of the liquid crystal display, and then an operation of the liquid crystal display is confirmed.

Referring to FIG. 2, in the display device according to the embodiment of the present inventive concept, the testing pad 730 is connected to the first voltage applying pad 710 and the second voltage applying pad 720.

The first voltage applying pad 710 is connected to the pads P1, P2, . . . , and Pn of the testing pad 730 through a plurality of pad connecting portions 715a, 715b, . . . , and 715x. That is, the first pad connecting portion 715a is connected to the first pad P1, and the second pad connecting portion 715b is connected to the second pad P2. In addition, the n-th pad connecting portion 715x is connected to the n-th pad Pn.

Further, diodes D1, D2, . . . , and Dn are disposed between the plurality of pad connecting portions 715a, 715b, . . . , and 715x and the first voltage applying pad 710. Specifically, the first diode D1 is disposed between the first pad connecting portion 715a and the first voltage applying pad 710. Similarly, the second diode D2 is disposed between the second pad connecting portion 715b and the first voltage applying pad 710, and the n-th diode Dn is disposed between the n-th pad connecting portion 715x and the first voltage applying pad 710. Each of the first diode D1, the second diode D2, and the n-th diode Dn is connected to a transistor.

The second voltage applying pad 720 is connected to the (n+1)-th pad Pn+1 of the testing pad 730 through a pad connecting portion 725. The (n+1)-th diode Dn+1 is disposed between the second voltage applying pad 720 and the pad connecting portion 725. The (n+1)-th diode Dn+1 is connected to the transistor. In FIG. 2, only the (n+1)-th pad connected to the second voltage applying pad 720 is illustrated for better comprehension and ease of description, but the present inventive concept is not limited thereto, and a plurality of pads may be disposed.

In a manufacturing process of the liquid crystal display according to the embodiment of the present inventive concept, a UV exposing process for forming the pretilt of the liquid crystal layer is performed. In this case, an alignment voltage used in the UV exposing process is supplied from the lower substrate through the first voltage applying pad 710 and the second voltage applying pad 720. Specifically, the probe for supplying the first voltage to the first voltage applying pad 710 is disposed and the probe for supplying the second voltage to the second voltage applying pad 720 is disposed, thus the first voltage and the second voltage may be applied to the display area DA.

The first voltage is transmitted to the pixel electrode, and the second voltage is transmitted to the common electrode. That is, the first voltage applying pad 710 supplies the pixel voltage to the pixel electrode of the lower substrate, and the second voltage applying pad 720 supplies the common voltage to the common electrode of the upper substrate.

The first voltage applying pad 710 is connected to the testing pad 730 to supply the pixel voltage to the display area DA without a separate short spacer. In addition, the second voltage applying pad 720 is connected to the common electrode disposed on the second substrate 200 through the testing pad 730, the short spacer 75 in the display area DA to supply the common voltage to the common electrode disposed on the second substrate 200, which is the upper substrate.

Since the liquid crystal display according to the present embodiment supplies the voltage required in the UV process through the testing pad 730 disposed on the lower substrate and connected to the display area DA, a process of cutting a pad portion for applying a common voltage to an upper plate during the UV process is not required. In addition, since a common voltage is applied through the upper plate in a conventional UV exposing process, a short seal disposed outside of the display area DA is required to connect the upper substrate and the lower substrate. When a position of the short seal is incorrect, a common voltage is not applied to the upper substrate of the liquid crystal display.

However, in the display device according to the present embodiment, since the common voltage is applied to the upper substrate using the testing pad 730 disposed on the lower substrate, the cutting process of the upper substrate may be omitted, thereby simplifying a manufacturing process. In addition, since the second voltage supplied from the first substrate 100, which is the lower substrate, is supplied to the second substrate 200, which is the upper substrate, through the short spacers already existing in the display area, there is no need to form a short seal outside of the display area, thereby preventing a problem caused by a position error of the short seal.

In the liquid crystal display according to the embodiment of the present inventive concept, the diodes Dn, Dn, and Dn+1 are disposed between the plurality of pad connecting portions 715a, 715b, . . . , 715x, and 725, and the first voltage applying pad 710 and the second voltage applying pad 720. The diodes D1, D2, . . . , Dn, and Dn+1 allow a current to flow from the first voltage applying pad 710 and the second voltage applying pad 720 only toward the testing pad 730.

Therefore, it is possible to prevent a residual current from flowing from the testing pad 730 toward the first voltage applying pad 710 and the second voltage applying pad 720. The diodes D1, D2, . . . , Dn, and Dn+1 are connected to the respective pads P1, P2, . . . , Pn, and Pn+1 one by one. Therefore, the signals of the respective pads are not overlapped during an inspection process of the panel.

The pixel voltages applied to the display area DA through the pads P1, P2, . . . , and Pn are supplied to the data lines of the respective pixels of the display area. In this case, the data lines of the respective pixels of the display area DA are connect one another at an edge of the display area DA, and no separate diode may exist between the connected portion of the data lines and the pads P1, P2, . . . , Pn.

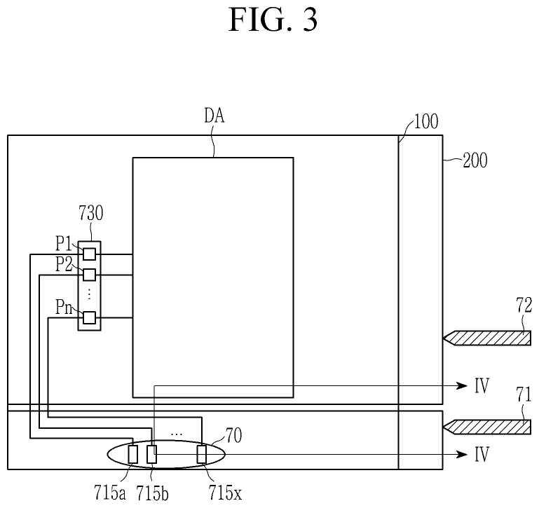

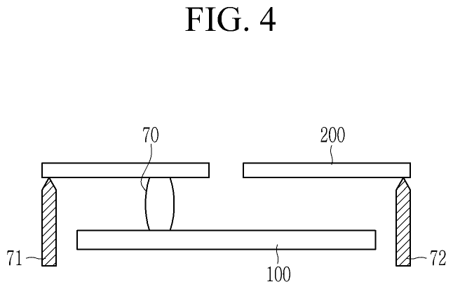

FIG. 3 illustrates a liquid crystal display according to a comparative example of the present inventive concept. FIG. 4 illustrates a cross-sectional view taken along line IV-IV of FIG. 3. Referring to FIG. 3 and FIG. 4, in a liquid crystal display device according to a comparative example of the present inventive concept, a portion of a first substrate 100 as a lower substrate is removed, and a second substrate 200 as an upper substrate is larger than the first substrate 100.

The first voltage and the second voltage are supplied through the second substrate 200 that does not overlap the first substrate 100. That is, the first voltage is supplied through a first electrode probe 71, and the second voltage is supplied through a second electrode probe 72. The first voltage may be the pixel voltage transmitted to the pixel electrode, and the second voltage may be the common voltage transmitted to the common electrode.

In the liquid crystal display according to the comparative example of the present inventive concept, since both the pixel voltage and the common voltage are supplied through the second substrate 200, the second substrate 200 must be cut to separate the two voltages. FIG. 3 and FIG. 4 illustrate the cut second substrate 200.

In addition, since the first voltage to be supplied to the first substrate 100 is supplied through the second substrate 200, a short seal 70 is disposed between the first substrate 100 and the second substrate 200. The short seal 70 is disposed outside of the display area DA and transmits the pixel voltage supplied from the second substrate 200 to the first substrate 100. Because the short seal 70 is formed through a separate process, the short seal 70 may be formed at a position different from a desired position thus the first voltage may not be supplied to the first substrate 100.

That is, in the liquid crystal display according to the comparative example of the present inventive concept, both the common voltage and the pixel voltage are supplied through the second substrate 200 as the upper substrate. Accordingly, the pixel voltage is supplied to the display area DA through the short seal 70, the pad connecting portions 715a, 715b, . . . , and 715x of the first substrate 100 and the plurality of pads P1, P2, . . . , Pn in the testing pad 730.

That is, in the liquid crystal display according to the comparative example of the present inventive concept, since both the common voltage and the pixel voltage are supplied through the second substrate 200 as the upper substrate, a process of cutting the upper substrate is required thus a process of forming a separate short seal 70 on the outside of the display area DA is required.

However, in the liquid crystal display according to the embodiment of the present inventive concept, since both the common voltage and the pixel voltage are supplied through the first substrate 100 as the lower substrate, the process of cutting the upper substrate is not required. In the liquid crystal display according to the present embodiment, even if the common voltage and the pixel voltage are supplied through the same first substrate 100, since the common voltage and the pixel voltage are separately transmitted as shown in FIG. 2, the process of cutting the first substrate is not required.

In addition, since the liquid crystal display according to the embodiment of the present inventive concept transmits the common voltage to the upper substrate through the short spacer disposed in the display area DA of the liquid crystal display, a process of forming a separate short seal outside of the display area DA is not required.

Therefore, the manufacturing process may be simplified and the defects of the liquid crystal display may be prevented.

Hereinafter, a manufacturing method of the liquid crystal display according to the embodiment of the present inventive concept will be described.

FIG. 5A to FIG. 5D illustrate a process of forming a pretilt of a liquid crystal display according to an embodiment of the present inventive concept.

Referring to FIG. 5A, the first substrate 100 and the second substrate 200 facing each other, and the liquid crystal layer disposed between the first substrate 100 and the second substrate 200 and including liquid crystal molecules 31 and a reactive mesogen 33, are prepared.

In this case, the first substrate 100 and the second substrate 200 may have a structure as shown in FIG. 1 and FIG. 2. That is, a portion of the first substrate 100 does not overlap with the second substrate 200, and the first voltage applying pad 710 and the second voltage applying pad 720 are disposed in an area in which the first substrate 100 and the first substrate 200 do not overlap.

Specific structures of the first substrate 100 and the second substrate 200 are the same as those described in FIG. 1 and FIG. 2. A detailed description of the same components will be omitted.

Referring to FIG. 5B, the pixel voltage is applied to the first substrate 100 and the common voltage is applied to the second substrate 200 to align the liquid crystal molecules 31 in a predetermined direction. In this case, the supply of the pixel voltage and the common voltage are the same as described above with reference to FIG. 1 and FIG. 2. A detailed description of the same components will be omitted. That is, the first voltage applying pad and the second voltage applying pad are disposed on one surface of the first substrate 100, the first voltage applying pad supplies the pixel voltage to the first electrode 191 disposed on the first substrate 100, and the second voltage applying pad supplies the common voltage to the second electrode 270 disposed on the second substrate 200 through the short spacer 75 in the display area DA. Due to a difference in voltages applied to the first electrode 191 and the second electrode 270, the liquid crystal molecules 31 are tilted in a predetermined direction.

Next, referring to FIG. 5C, the UV is irradiated in a state in which voltages are supplied to the first substrate 100 and the second substrate 200. In this case, the reactive mesogen 33 is photopolymerized by the UV irradiation. The reactive mesogen includes a photoreactive reactor such as an acrylate, and is polymerized with a photoreactor of a neighboring reactive mesogen.

As a result, a pretilt is formed on the liquid crystal molecules 31 as shown in FIG. 5D. Therefore, even when no voltage is supplied, the liquid crystal molecules 31 are tilted in a predetermined direction. As described above, when the pretilt is formed on the liquid crystal molecules 31, a response speed of the liquid crystal display may be increased.

Although not shown in FIG. 5A to FIG. 5D, a process of cutting a non-display area in which the first voltage applying pad 710 and the second voltage applying pad 720 of the liquid crystal display and the like are disposed may be further included.

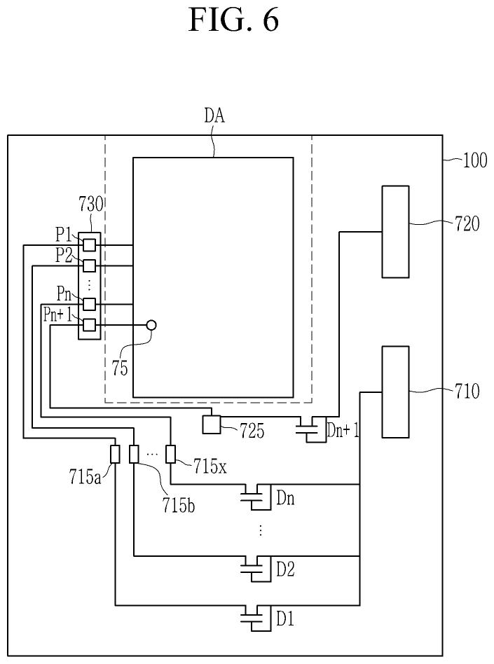

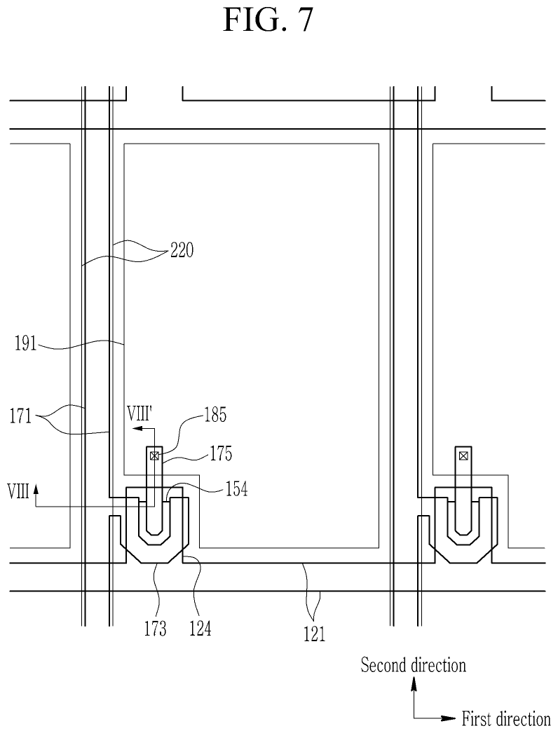

FIG. 6 illustrates a cutting line of the first substrate in a liquid crystal display. Referring to FIG. 6, a process of leaving only a region including the display area DA by cutting a portion indicated by a dotted line in FIG. 6 may be further included. Therefore, a finally manufactured liquid crystal display may include a region surrounded by a dotted line which includes the display area DA as disclosed in FIG. 6.

Hereinafter, a pixel structure of the display area DA of the liquid crystal display according to the embodiment of the present inventive concept will be described in detail with reference to the accompanying drawings. FIG. 7 illustrates a layout diagram of a liquid crystal display according to an embodiment of the present inventive concept, and FIG. 8 illustrates a cross-sectional view taken along line VIII-VIII′ of FIG. 7.

Referring to FIG. 7 and FIG. 8, the display panel 300 includes the first substrate 100, the second substrate 200 overlapping the first substrate 100, and the liquid crystal layer 3 disposed between the first substrate 100 and the second substrate 200.

First, the first substrate 100 will be described. A gate conductor including a gate line 121 and a gate electrode 124 is disposed on one surface of a first base substrate 110 made of transparent glass or plastic.

The gate line 121 may extend in a first direction. The gate conductor may include various metals or conductors, and may have a multi-layered structure. A gate insulating film 140 is disposed between the gate conductor and the liquid crystal layer 3. The gate insulating film 140 may include an inorganic insulating material.

A semiconductor layer 154 is disposed on one surface of the gate insulating film 140.

A data line 171 is disposed between the semiconductor layer 154 and the liquid crystal layer 3, extends in a second direction, and crosses the gate line 121. A source electrode 173 may extend from the data line 171 and overlap the gate electrode 124. A drain electrode 175 may be separated from the data line 171, and may have a bar shape extending to a center of the source electrode 173 as shown in FIG. 8.

A portion of the semiconductor layer 154 may not overlap the data line 171 and the drain electrode 175 in a region between the source electrode 173 and the drain electrode 175. The semiconductor layer 154 may have substantially the same planar shape as the data line 171 and the drain electrode 175 except for the portion that does not overlap.

One gate electrode 124, one source electrode 173, and one drain electrode 175 form one thin film transistor together with the semiconductor layer 154, and a channel of the thin film transistor corresponds to a region of the semiconductor layer 154 disposed between the source electrode 173 and the drain electrode 175.

A passivation film 180 is disposed between the source electrode 173 and drain electrode 175, and the liquid crystal layer 3. The passivation film 180 may include an inorganic insulating material such as a silicon nitride or a silicon oxide, an organic insulating material, a low dielectric constant insulating material, and the like.

The passivation film 180 is provided with a contact hole 185 which overlaps a portion of the drain electrode 175.

The first electrode 191 is disposed between the passivation film 180 and the liquid crystal layer 3. The first electrode 191 is physically and electrically connected to the drain electrode 175 through the contact hole 185, and receives a data voltage from the drain electrode 175. The first electrode 191 may be a pixel electrode.

A first alignment film 11 is disposed between the first electrode 191 and the liquid crystal layer 3.

The second substrate 200 includes a second base substrate 210, a light blocking member 220, the second electrode 270, and a second alignment film 21.

The second electrode 270 is disposed on one surface of the second base substrate 210. The second electrode 270 may be a common electrode.

The light blocking member 220 is disposed between the second base substrate 210 and the second electrode 270. The light blocking member 220 may overlap the data line 171 and extend in the second direction. Although not shown, the light blocking member may further include a horizontal portion overlapping the gate line 121 and extending in the first direction. However, the light blocking member 220 may be omitted. The second alignment film 21 is disposed between the second electrode 270 and the liquid crystal layer 3.

However, the structure described above is merely an example, and the structure of the liquid crystal display is not limited to the structures of FIG. 7 and FIG. 8.

As described above, the liquid crystal display and the manufacturing method thereof according to the embodiment of the present inventive concept may supply both the common voltage and the pixel voltage required in the UV exposing process for forming the pretilt through the first substrate 100 as the lower substrate, thus the process of cutting the upper substrate is not required. Therefore, the manufacturing process may be simplified. Since the diodes D1, D2, . . . , Dn, Dn+1 are disposed between the pad connecting portions 715a, 715b, . . . , 715x, and 725 and the first voltage applying pad 710 and the second voltage applying pad 720 of the first substrate 100, a voltage may be prevented from flowing in an opposite direction. In addition, since the common voltage is transmitted to the upper substrate through the short spacers disposed in the display area DA of the liquid crystal display, the process of forming a separate short seal outside of the display area DA is not required, thereby preventing defects of the liquid crystal display.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display comprising:
a first substrate including a display area and a non-display area;
a second substrate overlapping the first substrate;
a liquid crystal layer disposed between the first substrate and the second substrate; and
a testing pad disposed adjacent to the display area of the first substrate and connected to the display area,
wherein a first voltage applying pad and a second voltage applying pad disposed in a region of the first substrate that does not overlap with the second substrate, and
each of the first voltage applying pad and the second voltage applying pad is connected to the testing pad.

2. The liquid crystal display of claim 1, wherein
a first diode is disposed between the testing pad and the first voltage applying pad, and
a second diode is disposed between the testing pad and the second voltage applying pad.

3. The liquid crystal display of claim 2, wherein
each of the first diode and the second diode is connected to a transistor.

4. The liquid crystal display of claim 1, wherein
the testing pad includes a plurality of pads,
some of the plurality of pads are connected to the first voltage applying pad, and
some of the plurality of pads are connected to the second voltage applying pad.

5. The liquid crystal display of claim 1, wherein
a plurality of pad connecting portions are disposed between the first voltage applying pad and the testing pad, and
a pad connecting portion is disposed between the second voltage applying pad and the testing pad.

6. The liquid crystal display of claim 1, wherein
the testing pad is connected to a data line and a gate line of the display area.

7. The liquid crystal display of claim 1, wherein
a first electrode is disposed on the first substrate, and
a second electrode is disposed on the second substrate.

8. The liquid crystal display of claim 7, wherein
the testing pad is connected to a short spacer disposed in the display area, and
the short spacer is connected to the second electrode.

9. The liquid crystal display of claim 1, wherein
the first substrate is formed as a whole body.

10. A manufacturing method of a liquid crystal display, comprising:
preparing a mother substrate that includes a first substrate including a display area and a non-display area, a second substrate overlapping the first substrate, and a liquid crystal layer disposed between the first substrate and the second substrate;
applying a voltage to the mother substrate; and
forming a pretilt in the liquid crystal layer by irradiating UV on the mother substrate to which the voltage is applied,
wherein the first substrate includes a testing pad disposed adjacent to the display area of the first substrate and connected to the display area,
a first voltage applying pad and a second voltage applying pad are disposed in a region of the first substrate that does not overlap with the second substrate, and
each of the first voltage applying pad and the second voltage applying pad is connected to the testing pad.

11. The manufacturing method of the liquid crystal display of claim 10, wherein
in the applying of the voltage to the mother substrate,
a voltage applying probe contacts each of the first voltage applying pad and the second voltage applying pad to apply the voltage.

12. The manufacturing method of the liquid crystal display of claim 10, wherein
the liquid crystal layer includes a liquid crystal molecule and a reactive mesogen.

13. The manufacturing method of the liquid crystal display of claim 12, wherein
the reactive mesogen includes a photoreactor.

14. The manufacturing method of the liquid crystal display of claim 10, wherein
a first diode is disposed between the testing pad and the first voltage applying pad, and
a second diode is disposed between the testing pad and the second voltage applying pad.

15. The manufacturing method of the liquid crystal display of claim 14, wherein
each of the first diode and the second diode is connected to a transistor.

16. The manufacturing method of the liquid crystal display of claim 14, wherein
the testing pad includes a plurality of pads,
some of the plurality of pads are connected to the first voltage applying pad, and
some of the plurality of pads are connected to the second voltage applying pad.

17. The manufacturing method of the liquid crystal display of claim 14, wherein
a plurality of pad connecting portions are disposed between the first voltage applying pad and the testing pad, and
a pad connecting portion is disposed between the second voltage applying pad and the testing pad.

18. The manufacturing method of the liquid crystal display of claim 17, further comprising
cutting and removing a non-display area in which the first voltage applying pad, the second voltage applying pad, the first diode, the second diode, and the plurality of pads are disposed from the mother substrate.

19. The manufacturing method of the liquid crystal display of claim 14, wherein
a first voltage is supplied to a first electrode of the display area via the first voltage applying pad, the plurality of pad connecting portions, the testing pad.

20. The manufacturing method of the liquid crystal display of claim 14, wherein
a second voltage is supplied to a second electrode of the display area via the second voltage applying pad, the pad connecting portion, the testing pad and a short spacer disposed in the display area.
